(19) United States
(12) Patent Application Publication
(10) Pub. No.: US 2024/0243246 A1
(43) Pub. Date: Jul. 18, 2024

(54) SOLID STATE ADDITIVES FOR IRON NEGATIVE ELECTRODES

(71) Applicant: Form Energy, Inc., Somerville, MA (US)

(72) Inventors: David Hooke, Somerville, MA (US); Michael Andrew Gibson, Somerville, MA (US); Annelise Christine Thompson, Somerville, MA (US); Joseph Anthony Pantano, Canton, MA (US); Marc Louis Syvertsen, Madison, WI (US)

(21) Appl. No.: 18/479,668

(22) Filed: Oct. 2, 2023

Related U.S. Application Data
(63) Continuation-in-part of application No. 18/451,458, filed on Aug. 17, 2023.
(60) Provisional application No. 63/378,132, filed on Oct. 3, 2022.
(60) Provisional application No. 63/398,828, filed on Aug. 17, 2022.
(60) Provisional application No. 63/378,132, filed on Oct. 3, 2022.

(51) Int. Cl. H01M 4/04; H01M 4/02; H01M 4/38; H01M 4/62

(52) U.S. Cl. CPC H01M 4/0471; H01M 4/38; H01M 4/62; H01M 2004/027

(57) ABSTRACT

According to one aspect, an additive for an iron negative electrode of an alkaline electrochemical cell may include a powder of discrete granules including agglomerated particles, the agglomerated particles including at least one metal sulfide.

### CROSS-REFERENCE TO RELATED APPLICATIONS

This application is claims the benefit of priority to U.S. Provisional Patent Application 63/378,132 filed Oct. 3, 2022 and is a continuation-in-part of, and claims the benefit of priority to, U.S. Non-Provisional application Ser. No. 18/451,458 filed Aug. 17, 2023 which claims the benefit of priority to U.S. Provisional Patent Application 63/398,828 filed Aug. 17, 2022 and to U.S. Provisional Patent Application 63/378,132 filed Oct. 3, 2022, with the entire contents of all of these applications hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultralong (collectively, >8 h) energy storage systems. Of benefit are potentially low-cost rechargeable battery chemistries that can enable long duration large scale energy storage.

### SUMMARY

According to one aspect, an additive for an iron negative electrode of an alkaline electrochemical cell may include a powder of discrete granules including agglomerated particles, the agglomerated particles including at least one metal sulfide.

In some implementations, the at least one metal sulfide of the agglomerated particles is greater than 50 wt % of the discrete granules. The at least one metal sulfide of the agglomerated particles may have greater than 80 wt % of the discrete granules.

In certain implementations, the discrete granules may have a mean particle size of greater than about 30 microns and less than about 800 microns on a weight percentage basis.

In some implementations, the discrete granules of the agglomerated particles of the at least one metal sulfide may have a median pore size of greater than about 75 nanometers and less than about 15 microns as determined by mercury intrusion porosimetry.

In certain implementations, the discrete granules may have a first average apparent density, the particles including the at least one metal sulfide have a second average apparent density, and the first average apparent density is less than the second average apparent density. The first average apparent density may be greater than 1.0 grams per cubic centimeter and less than 2.1 grams per cubic centimeter.

In some implementations, the discrete granules may have a friability of less than about 15% weight loss according to European Pharmacopoeia 2.9.41.-2 (Method B).

In certain implementations, solid-state bonding may hold at least some of the agglomerated particles together in the discrete granules possess solid state bonding between the agglomerated particles.

In certain implementations, at least some of the agglomerated particles of the discrete granules may be a metal-matrix composite bonded through infiltration.

In some implementations, the discrete granules may include a binder, and at least some of the agglomerated particles of the discrete granules are bonded by the binder. As an example, the binder may be soluble in and/or reactive to form a species soluble in an alkaline electrolyte.

In certain implementations, the at least one metal sulfide may include zinc sulfide (ZnS). The powder of the discrete granules may be greater than or equal to 90% by weight zinc sulfide (ZnS). As an example, greater than 60% by weight of the zinc sulfide (ZnS) may be the sphalerite structure, as determined by x-ray diffraction.

In some implementations, the agglomerated particles of the discrete granules may have surface-connected porosity. As an example, the surface-connected porosity of the agglomerated particles may be greater than or equal to 7 vol. % and less than or equal to 40 vol. % of the agglomerated particles, as determined by mercury intrusion porosimetry.

In certain implementations, the at least one metal sulfide may include iron sulfide (FeS), tin sulfide (SnS), bismuth sulfide (Bi₂S₃), aluminum sulfide (Al₂S₃), antimony(III) sulfide (Sb₂S₃), antimony(V) sulfide (Sb₂S₅), manganese sulfide (MnS), molybdenum(IV) sulfide (MoS₂), or combinations thereof.

In some implementations, the discrete granules may further include tin oxide (SnO₂), tin (Sn), bismuth (Bi), zinc selenide (ZnSe), potassium hydroxide (KOH), sodium hydroxide (NaOH), or combinations thereof.

In certain implementations, the discrete granules may further include an electrically conductive material. As an example, the electrically conductive material may include tin, graphite, carbon black, or a combination thereof.

In some implementations, the discrete granules may further include particles of at least one pore former. The particles of the at least one pore former may have a mean particle size of greater than about 5 microns and less than about 20 microns on a weight percentage basis. In some instances, the particles of the at least one metal sulfide may have a first mean particle size on a weight percentage basis, and the particles of the at least one pore former have a second mean particle size on a weight percentage basis, and the second mean particle size is greater than or equal to the first mean particle size. In certain instances, the at least one pore former may be soluble in an alkaline electrolyte. As an example, the at least one pore former may include potassium oxide (K₂O), lithium oxide (LiO), sodium oxide (Na₂O), potassium hydroxide (KOH), lithium hydroxide (LiOH), sodium hydroxide (NaOH), sodium sulfate (Na₂S), potassium sulfate (K₂S), sodium carbonate (Na₂CO₃), potassium carbonate (K₂CO₃), sodium stannate (Na₂[Sn(OH)₆]), potassium stannate (K₂[Sn(OH)₆]), or combinations thereof. Further, or instead, the at least one pore former may include poly(methyl methacrylate), starch, sodium chloride (NaCl), potassium chloride (KCl), ammonium bicarbonate (NH₄HCO₃), or a combination thereof.

According to another aspect, an iron negative electrode for an alkaline electrochemical cell may include a first powder including an iron active material, and a second powder including the additive of any one or more of the powders described above, the first powder and the second powder forming a powder blend in which the second powder is dispersed relative to the first powder.

In certain implementations, the first powder may include any one or more of an iron oxide, an atomized iron powder, iron sponge powder, or a milled iron powder. As an example, a ratio of the mean particle size of the discrete granules of the second powder to the mean particle size of particles of the iron active material may be 0.5 to 2.

In some implementations, the mean particle size of the discrete granules may be greater than or equal to a mean pore size of the powder blend.

In certain implementations, the apparent density of the powder blend may be less than the apparent density of the first powder alone.

In some implementations, the iron active material may be greater than about 70% of the combined weight of the first powder and the second powder.

In certain implementations, an active layer strata of the electrode may have a thickness of greater than about 8 mm and less than about 50 mm.

In some implementations, concentration of the second powder in the powder blend may have a predetermined gradient in a thickness dimension of the active layer strata. along in the powder blend.

According to still another aspect, a method of making an additive for an iron negative electrode of an alkaline electrochemical cell may include forming a feedstock including a particulate material having a predetermined composition, and processing the feedstock including the particulate material into a powder of discrete granules including agglomerated particles of the particulate material, the agglomerated particles including at least one metal sulfide.

In some implementations, processing the feedstock of the particulate material may include solid-state bonding of the particulate material. As an example, the solid-state bonding of the particulate material may include heating the particulate material to a temperature of between about 500° C. to about 1400° C. Further, or instead, solid-state bonding of the particulate material may include sintering the particulate material into the agglomerated particles. As an example, the at least one metal sulfide includes zinc sulfide (ZnS), and sintering is carried out at a temperature greater than 900° C. and less than 1300° C. In certain instances, solid-state bonding of the particulate material may include hot pressing the particulate material. As an example, the at least one metal sulfide may include zinc sulfide (ZnS), and hot pressing is carried out at 900° C. with uniaxial pressure of about 410 kPa for about 10 minutes.

In certain implementations, forming the feedstock may include introducing at least one polymeric binder to the particulate material. In some instances, processing the feedstock into the discrete granules may include pyrolyzing the at least one polymeric binder to form a graphitized film on the particulate material. The at least one polymeric binder may be pyrolizable in an inert atmosphere with >7 wt % yield of residual solids after pyrolysis in non-oxidizing atmosphere up to 600° C. Further, or instead, the at least one polymeric binder may include pitch, zinc stearate, stearic acid, polymerized alcohols, poly(methyl methacrylate), polyolefins, polymers with aromatic rings, poly(ethylene glycol), poly(tetrafluoroethylene), polyvinylidene fluoride, carboxymethylcellulose, poly(acrylic acid), or copolymers of any one or more of the foregoing. Still further or instead, with the at least one polymeric binder introduced to the particulate material, the particulate material may be thermomechanically bonded in a processing atmosphere including hydrogen gas.

In some implementations, forming the feedstock may include introducing at least one inorganic binder to the particulate material. The at least one inorganic binder may include an oxide-based binder, a silicate-based binder, an alumina-containing binder, or a combination thereof.

In certain implementations, processing the feedstock of the particulate material further includes compacting the feedstock of particulate material. As an example, compacting the feedstock of the particulate material includes roller compaction of the feedstock of the particulate material.

In some implementations, the particulate material may include particles of the at least one metal sulfide. Forming the feedstock of the particulate material may include mixing at least two metal sulfides together in a predetermined weight ratio relative to one another. As an example, the at least two metal sulfides may include zinc sulfide (ZnS) and iron sulfide (FeS). In some instances, the at least two metal sulfides may include zinc sulfide (ZnS) and iron sulfide (FeS) in the predetermined weight ratio relative to one another in the discrete granules. In certain instances, forming the feedstock including the particulate material may include mixing an electrically conductive material with the at least one metal sulfide. As an example, the electrically conductive material may include tin, graphite, carbon black, or a combination thereof. In certain instances, the electrically conductive material may be a solid at room temperature, processing the feedstock of the particulate material includes heating the feedstock of the particulate material in an inert environment to melt the at least one metal sulfide and the electrically conductive material such that the electrically conductive material wets the at least one metal sulfide and, with the electrically conductive material wetting the at least one metal sulfide, cooling the feedstock of the particulate material such that the at least one metal sulfide and the electrically conductive material in the feedstock of the particulate material forms a metal-matrix composite bonded through infiltration. In some implementations, particles of the at least one metal sulfide may include particles of zinc sulfide (ZnS). In some instances, processing the feedstock may include exposing the particulate material to a chemically reducing environment including one or more reductants at 700° C. to 1000° C. such that zinc oxide (ZnO) in the particulate material is chemically reduced to zinc sulfide (ZnS). The one or more reductants may include solid state carbon, gaseous carbon monoxide, or gaseous hydrogen. In some instances, processing the feedstock may include exposing the particulate material to a sulfur-containing gas to convert zinc oxide (ZnO) to zinc sulfide (ZnS). As an example, the sulfur-containing gas may include hydrogen sulfide (H₂S), carbonyl sulfide (OCS), methane thiol (CH₃SH), sulfur dioxide (SO₂), or combinations thereof. In some instances, forming the feedstock of particulate material may include blending particles of a pore former with the particles of the at least one metal sulfide, and the pore former is soluble in alkaline electrolyte. In some instances, a ratio of the mean particle size of the particles of the pore former to the mean particle size of the particles of the at least one metal sulfide may be greater than or equal to 1:1 and less than about 5:1.

In certain implementations, processing the feedstock into the discrete granules may include introducing at least one binder to the discrete granules, and the at least one binder is soluble in an alkaline electrolyte.

In some implementations, processing the feedstock into the discrete granules may include forming the particulate material into one or more intermediate bodies, and changing the size of the one or more intermediate bodies to form the discrete granules. Forming the particulate material into the one or more intermediate bodies may include cold pressing the particulate material. Cold pressing the particulate material may include forming briquettes of the particulate material. In some instances, changing the size of the one or more intermediate bodies to form the discrete granules may include sintering the one or more intermediate bodies together to form the discrete granules. As an example, forming the particulate material into the one or more intermediate bodies may include sintering the particulate material into a sintered body having at least one dimension on the order of 1 mm or larger, and changing the size of the one or more intermediate bodies includes reducing the size of the one or more intermediate bodies to form the discrete granules. In some instances, the one or more intermediate bodies may include a monolithic body of ceramic material, the monolithic body having at least one dimension on the order of 1 mm or larger, and changing the size of the one or more intermediate bodies includes reducing the size of the one or more intermediate bodies to form the discrete granules. In certain instances, changing the size of the one or more intermediate bodies to form the discrete granules may include any one of or more of: milling; drum granulation; fluid bed granulation; spray-drying; high shear mixer granulation; twin screw granulation; extrusion granulation; open pan/disc pelletizing; wet granulation; or dry granulation.

Various aspects may include methods for making electrodes for batteries. Aspects may include a method for making an electrode for a battery that may include forming an electrode structure comprising an iron active material and a source of zinc, and converting the source of zinc to zinc-sulfide on or in the electrode structure through a sulfidation reaction. In some implementations, the source of zinc may include a zinc oxide powder. Aspects may include a method for making an electrode for a battery that may include contacting an electrode structure comprising an iron active material with a solution comprising dissolved zinc, and exposing the solution contacted structure to a sulfide source to convert at least a portion of the dissolved zinc to zinc sulfide. In some implementations, the sulfide source may include a solution comprising Na₂S. In some implementations, the sulfide source may include a gas comprising H₂S. In some implementations, the solution comprising dissolved zinc may include a solvent and a gelling agent. Some implementations may further include drying the exposed solution contacted structure, wherein the drying occurs at one or more temperatures at or below 800 degrees Celsius. In some implementations, the drying occurs in a furnace. Aspects may include a method for making an electrode for a battery that may include forming a sulfidation solution comprised of a solvent and a sulfide source, forming an electrode structure comprising an iron active material and a solid zinc source, contacting the electrode structure with the sulfidation solution, and maintaining the sulfidation solution in contact with the electrode structure for a period of time such that zinc sulfide is incorporated on or in the electrode structure. In some implementations, the sulfidation solution may be a component of an electrolyte solution, and contacting the electrode structure with the sulfidation solution may include adding the sulfidation solution to a battery cell including the electrode structure such that the sulfidation solution contacts the electrode structure. In some implementations, the solvent comprises KOH and the sulfide source comprises Na₂S. In some implementations, the solid zinc source is formed from solid zinc oxide particles or agglomerated particles of zinc oxide. In some implementations, a molar ratio of Na₂S in the sulfidation solution to zinc oxide in the electrode structure is between 1 and 2. In some implementations, the period of time may be less than 168 hours. Aspects may include a method for making an electrode for a battery that may include forming a structure comprising an iron active material and a solid source of zinc by one or more processes performed at or above a first processing temperature, and exposing the formed structure to a sulfide source gas while maintaining a selected concentration of the sulfide source gas. The one or more processes performed at or above the first processing temperature may comprise one or more of sintering and hot pressing. In some implementations, exposing the formed structure to the sulfide source gas while maintaining the selected concentration of the sulfide source gas may include exposing the formed structure to the sulfide source gas while maintaining the selected concentration of the sulfide source gas and a second processing temperature that is below the first processing temperature such that a sulfidation reaction of the zinc oxide occurs to form zinc sulfide. In some implementations, the first processing temperature may be at or above 800 degrees Celsius and the second processing temperature may be at or below 600 degrees Celsius. In some implementations, the second processing temperature may be at or below 400 degrees Celsius.

In some implementations, the sulfide source gas is H₂S and the selected concentration of the sulfide source gas is between 0.25% and 1%. In some implementations, the exposing the formed structure to the sulfide source gas occurs as part of a cooling phase of a last of the one or more processes used to form the formed structure. In some implementations, the zinc oxide is formed from solid zinc oxide particles or agglomerated particles of zinc oxide.

### DESCRIPTION OF THE DRAWINGS

FIG. 1A is a schematic representation of an electrochemical cell.

FIG. 1B is a schematic representation of a rechargeable battery.

FIG. 2A is a schematic representation of an iron-negative electrode including a bed of a powder blend, the powder blend including a first powder of an iron-containing active material and a second powder of an additive material.

FIG. 2B is a close-up schematic representation of the second powder of FIG. 2A, the second powder including discrete granules including agglomerated particles, the agglomerated particles including at least one metal sulfide.

FIG. 2C is an image showing a powder of discrete granules of agglomerated particles mixed with a powder of iron active material.

FIG. 3 is a series of graphs of measured capacity (normalized) of the iron negative electrode of FIG. 2A as a function of mean particle size of the discrete granules of the iron negative electrode of FIG. 2A, with the type of metal sulfide held constant and the different graphs corresponding to experiments performed using variations in electrolyte, concentration of the electrolyte, amount of the discrete granules used (wt %), and cycling conditions such as temperature and C-rate.

FIG. 4 is a flowchart of an exemplary method 400 of making an additive for an iron negative electrode of an alkaline electrochemical cell.

FIGS. 5A and 5B are zinc sulfide (ZnS) phase diagrams.

Like reference symbols in the various drawings indicate like elements.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but rather to enable a person skilled in the art to make and use this disclosure. Unless otherwise noted, the accompanying drawings are not drawn to scale.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present disclosure. These examples are for illustrative purposes, may be prophetic, and should not be viewed as limiting, and do not otherwise limit the scope of the present disclosure.

The various embodiments of systems, equipment, techniques, methods, activities, and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present disclosure should not be limited to a particular embodiment, configuration or arrangement that is set forth in a particular embodiment, example, or in an embodiment in a particular figure.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Unless otherwise specified or made clear from the context, all references to mean particle size herein shall be understood to refer to mean particle size on a weight percentage basis. Thus, some references to mean particle size herein may occasionally omit specific mention of “weight percentage basis” for the sake of clarity and readability.

Embodiments of the present disclosure include apparatuses, systems, and methods for long-duration, and ultra-long-duration energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage devices or systems may refer to energy storage devices or systems that may be configured to store energy over time spans of days, weeks, or seasons. For example, the energy storage devices or systems may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present invention includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, said invention may include energy storage used as backup power when the electricity supplied by the power grid is insufficient, for installations including homes, commercial buildings, factories, hospitals, or data centers, where the required discharge duration may vary from a few minutes to several days.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

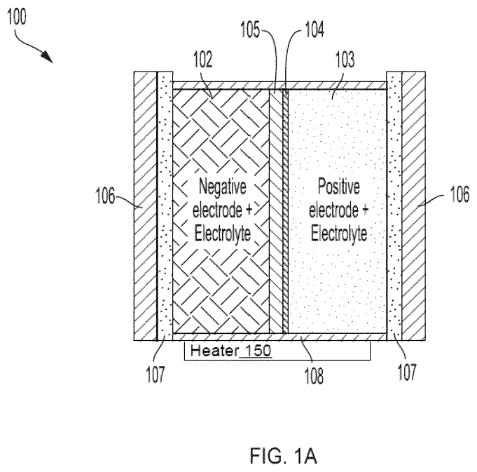

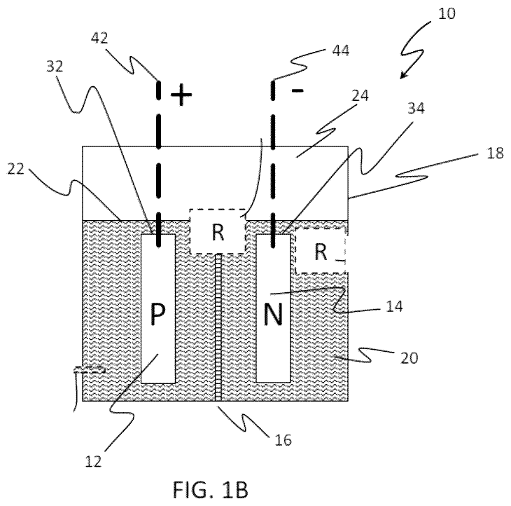

Referring now to FIG. 1A, an electrochemical cell 100 (e.g., a battery) may include a negative electrode 102 separated from a positive electrode 103 by a separator 104. The separator 104 may be supported, for example, by a mesh 105 (e.g., a polypropylene mesh) and a frame 108 (e.g., polyethylene or polypropylene) of the electrochemical cell 100. Current collectors 107 may be associated with respective ones of the negative electrode 102 and positive electrode 103 and supported by backing plates 106 (e.g., polyethylene or polypropylene backing plates). In some embodiments, the temperature of the electrochemical cell 100, may be controlled, such as by insulation around the electrochemical cell 100 and/or by a heater 150. For example, the heater 150 may raise the temperature of the electrochemical cell 100 and/or specific components of the cell, such as an electrolyte infiltrated in the negative electrode 102 and the positive electrode 103. The electrolyte may be an aqueous solution. In certain embodiments the electrolyte may be an alkaline solution (pH>10). In certain embodiments, the electrolyte may be a near-neutral solution (10>pH>4).

The electrochemical cell 100 is merely an example of one electrochemical cell configuration according to various embodiments and is not intended to be limiting. Other configurations, such as electrochemical cells with different type meshes and/or without the mesh 105, electrochemical cells with different type frames and/or without the frame 108, electrochemical cells with different type current collectors and/or without the current collectors 107, electrochemical cells with reservoir structures, electrochemical cells with different type backing plates and/or without the backing plates 106, electrochemical cells with different type insulation and/or without insulation, and/or electrochemical cells with different type heaters and/or without the heater 150, may be substituted for the example configuration of the electrochemical cell 100 shown in FIG. 1A and other configurations are in accordance with the various embodiments.

In some embodiments, a plurality of electrochemical cells 100 in FIG. 1A may be connected electrically in series to form a stack. In certain other embodiments, a plurality of electrochemical cells 100 may be connected electrically in parallel. In certain other embodiments, the electrochemical cells 100 are connected in a mixed series-parallel electrical configuration to achieve a favorable combination of delivered current and voltage.

Referring now to FIG. 1B, a rechargeable battery 10 may include a positive electrode 12, a negative electrode 14, and a separator 16 within a container 18 filled with electrolyte 20 to a level 22 at least as high as the respective tops 32, 34 of the electrodes 12, 14. The space above the level 22 of the electrolyte 20 may be referred to as the headspace 24. The positive electrode 12 may be electrically connected to a positive terminal 42 of the rechargeable battery 10 and may contain active material that may undergo reduction reactions during discharging and oxidation reactions during charging. The negative electrode 14 may be electrically connected to a negative terminal 44 of the rechargeable battery 10 and may contain active material that may undergo oxidation reactions during discharging and reduction reactions during charging of the rechargeable battery 10. The rechargeable battery 10 in FIG. 1B is merely an example of one electrochemical cell according to various embodiments and is not intended to be limiting.

In various embodiments, the electrolyte 20 may be an aqueous or non-aqueous alkaline, neutral, or acidic solution. For example, the electrolyte solution may contain potassium hydroxide (KOH), sodium hydroxide (NaOH), lithium hydroxide (LiOH) or combinations of these.

In some embodiments, a battery 10 may include a separator 16 that allows transfer of ions between the electrodes 12, 14 via the electrolyte. In some embodiments, a separator may be chosen based on an ability to allow selective transfer of desired molecules or materials while substantially limiting or preventing transfer of undesired molecules or materials. For example, some separator membranes are ion-selective and allow the transfer of negative (or positive) ions while substantially preventing transfer of positive (or negative) ions. In other examples, separator materials may be chosen based on an ability to allow or prevent the cross-over of gas bubbles from one side (associated with one electrode) to the opposite side (associated with the counter-electrode).

In various embodiments, the container 18 may be made of any suitable materials and construction capable of containing the electrolyte, electrodes, and at least a minimum amount of gas pressure. For example, the container 18 may be made of metals, plastics, composite materials, or others. In some embodiments, the battery container 18 may be sealed so as to prevent the escape of any gases generated during operation of the battery.

In some embodiments, the battery container 18 may include a pressure relief valve to allow release of gases when a gas pressure within the battery container 18 exceeds a pre-determined threshold.

While the electrodes 12, 14 are shown substantially spaced apart in the figures, in some embodiments the electrodes may be very close to one another or even compressed against one another with a separator 16 in between. Furthermore, although the figures may illustrate a single positive electrode 12 and a single negative electrode 14, battery systems within the scope of the present disclosure may also include two or more positive electrodes 12 and/or two or more negative electrodes 14.

Referring now to FIGS. 1A and 1B, it shall be generally understood that the negative electrode 102 of the electrochemical cell 100 and/or the negative electrode 14 of the rechargeable battery 10 may include metal or metal oxides such as iron, zinc, cadmium, or other metals and/or oxides or hydroxides of these or other metals, unless otherwise specified or made clear from the context. Further, it shall be generally understood that the negative electrode 102 of the electrochemical cell 100 and the negative electrode 14 of the rechargeable battery 10 have similar or identical features, unless otherwise indicated or made clear from the context and, for the sake of efficient description, these are not described separately for each negative electrode. Thus, in view of the foregoing, embodiments in the description that follows are described in the context of the negative electrode 14 and, more specifically, in the context of the negative electrode 14 as an iron negative electrode. Accordingly, the negative electrode 14 shall be referred to hereinafter as “the iron negative electrode 14” and all such references shall be understood to be intended to encompass references to other types of active metals described herein and to other negative electrodes described herein (e.g., to the negative electrode 102), unless otherwise specified or made clear from the context.

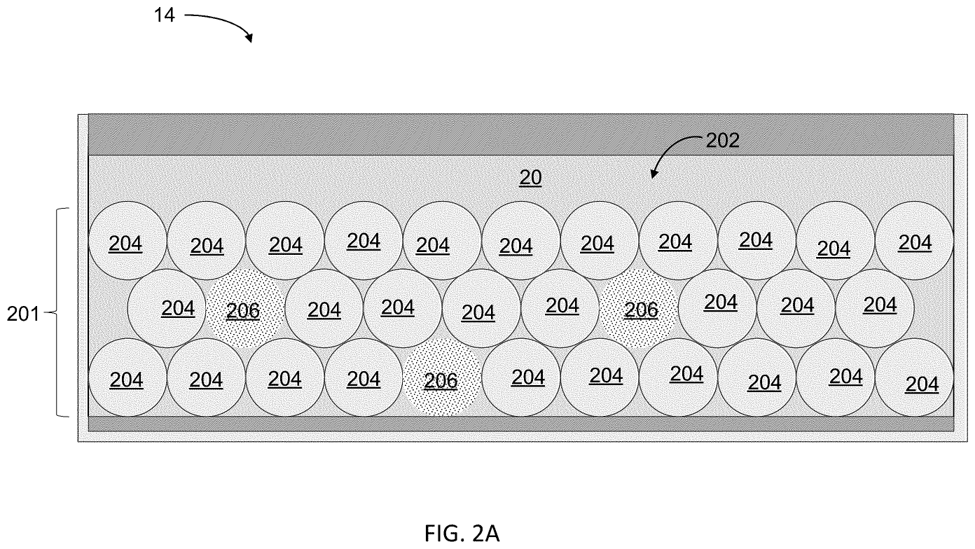

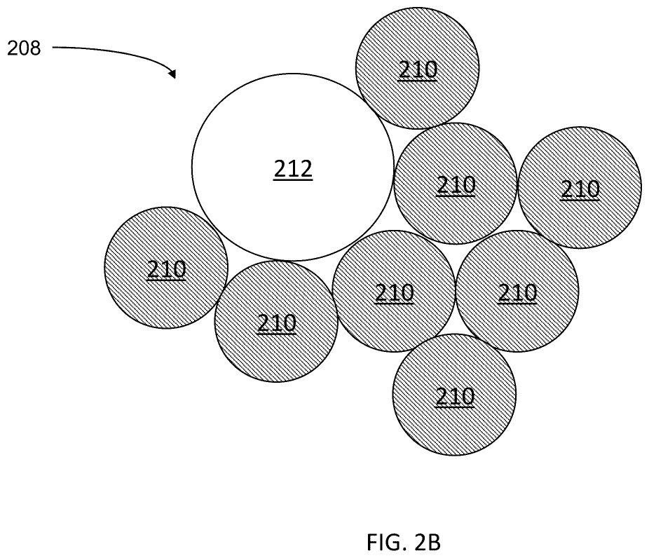

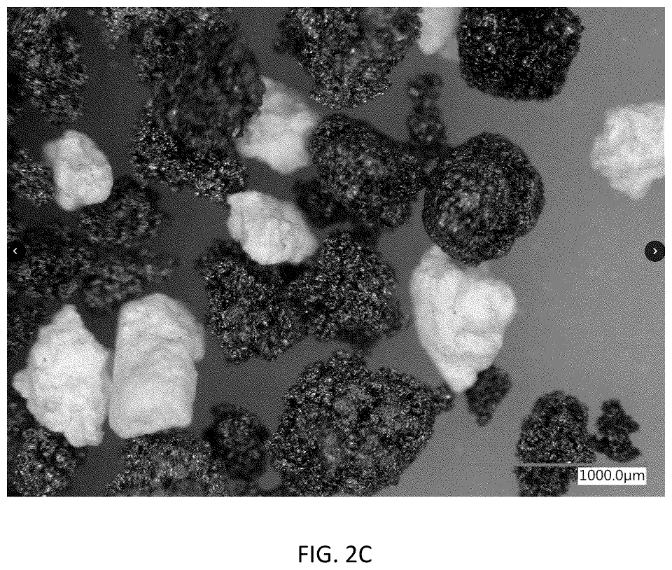

Referring now to FIG. 1B and FIGS. 2A and 2B, the iron negative electrode 14 may include a bed 201 of a powder blend 202 having porosity through which an electrolyte (e.g., the electrolyte 20 in FIG. 1B) may infiltrate the bed 201 iron negative electrode 14 to support the flow of ions as iron active material of the negative electrode 14 undergoes oxidation and reduction during operation of an electrochemical cell (e.g., the rechargeable battery 10). The powder blend 202 may include a first powder 204 and a second powder 206. As described in greater detail below, the first powder 204 may include an iron active material. As also described in greater detail below, the second powder 206 may include discrete granules 208 including agglomerated particles 210 including at least one metal sulfide. As an example, the iron active material may be greater than about 70% of the combined weight of the first powder 204 and the second powder 206, as may be useful balancing competing considerations associated with performance (e.g., capacity utilization of the iron active material), cost, and size of an electrochemical cell (e.g., the rechargeable battery 10) including the iron negative electrode 14.

In general, as described in the paragraphs that follow, the discrete granules 208 of the agglomerated particles 210 overcome significant challenges of particle size matching, dry powder processing, and floataway/fallout risk, as compared to the use of a powder of loose particles of a solid-state additive in an iron negative electrode.

As one example, the second powder 206 including the discrete granules 208 of the agglomerated particles 210 including the additive material may facilitate overcoming design challenges typically associated with particle size mismatches between the active material and the additive material in iron negative electrodes. Specifically, to achieve cost-effective production at scale, many solid-state additive powders are formed using manufacturing techniques that produce small particle sizes. While small particle sizes (e.g., <<100 microns) may be useful for achieving dissolution rates of certain types of solid-state additives (e.g., manganese sulfide, tin-containing additives, and zinc sulfide) in an electrolyte in an iron negative electrode, these small particle sizes are generally incompatible with the large particle sizes of the iron active material, with such large particle sizes needed to achieve packing and flow properties required for efficient performance of an iron negative electrode. Stated differently, there is generally a particle size mismatch between a powder of loose particles of additives (typically <10 microns) and a powder of iron active material (typically 100s of microns).

As a result of this size contrast between solid additives and the iron powders used, the powder mixes used in iron negative electrodes may attain higher packing densities than desired, with the smaller particles of the sold-state additive packing into the interstitial spaces of the larger particles of the iron active material due to purely geometric effects. Further, or instead, if the particles of the solid-state additive are sufficiently small relative to the larger particles of the iron active material, the particles of the solid-state additive can act as “flow enhancers” or “packing enhancers” by lowering interparticle friction. Such higher packing densities may result in iron negative electrodes with low porosities, leading to poor performance of the resultant iron negative electrode. In this context, such poor performance may be attributable to at least one or more of rate capability, attainable areal loading, specific capacity, and voltage efficiency. However, the use of agglomeration of particles to form the granules 208 the second powder 206 facilitates overcoming the particle size mismatch between loose particles of solid-state additives and iron powders for use in powder mixes for iron negative electrodes. Further, or instead, the use of agglomeration of particles to form the discrete granules 208 of an additive decouples the geometry of the particles of the solid-state additive from the performance of the solid-state additive in the iron negative electrode 14—facilitating independent control of specific surface area of the additive material, additive chemistry, size of particles of the additive in the powder blend 202 in the bed 201, or any combination thereof.

As another example, the second powder 206 including the discrete granules 208 of the agglomerated particles 210 facilitates the use of dry powder processing to form the iron negative electrode 14. In the aqueous long duration energy storage context, electrode areal loadings and thicknesses are much higher than in other battery electrode contexts. As a point of comparison, lithium-ion electrodes (commonly used for shorter duration energy storage technologies) typically have an active layer strata usually less than ˜1 mm in thickness, whereas the iron negative electrode 14 may have an active layer strata that is greater than about 8 mm to less than about 50 mm in thickness. As used in this context, it shall be appreciated that the thickness of the active layer strata refers to the thickness of the layer of the iron negative electrode 14 containing the first powder 204 including the iron-active material (and, thus, also containing the second powder 206 as part of the powder blend 202). Wet, slurry-based processing and slurry rheology are commonly used in the production of lithium-ion electrodes to maintain a homogeneous mix of electrode active materials, additives, and binders, throughout the process of creating an active layer. However, the drying time of a wet-processed electrode increases super-linearly with increasing thickness of the active layer material, making the use of wet processing impractical in instances in which the iron negative electrode 14 has a dramatically thicker format than lithium-ion electrodes. While dry powder processing offers advantages over wet processing with respect to fabrication time, the effects of powder rheology and attendant segregation tendencies can be much more severe in dry powder processing than in wet electrode processing.

Therefore, for fabrication of the iron negative electrode 14 using dry powder processing of the powder blend 202, particularly close attention must be paid to considerations surrounding particle size engineering to meet criteria for desired powder packing (for high performance) and consistency while taking the different constraints into effect. Thus, while the second powder 206 including discrete granules 208 of the agglomerated particles 210 may be relevant to any processing route, the second powder 206 may be particularly useful in the context of dry-processing to form the powder blend 202 of the iron negative electrode 14. That is, dry-processing the second powder 206 to form the powder blend 202 may facilitate simultaneously meeting the performance-based requirements of surface area and dispersion of the additive material within the iron negative electrode 14 while also meeting the processing-based requirements of particle size matching and segregation minimization.

As yet another example, the second powder 206 including the discrete granules 208 of the agglomerated particles 210 including the additive material may facilitate mitigating floataway/fallout risk of solid-state additives in iron-negative electrodes. That is, a specific risk associated with using solid-state additives in iron negative electrodes is that these the particles of such solid-state additives may adhere to or otherwise be bound or dragged by bubbles produced during electrochemical cycling (by, e.g. hydrogen evolution or oxygen evolution), causing loss of the loose particles of the solid state additive from the iron negative electrode. This may be particularly problematic in instances in which the solid state additive is intended to stay in the iron negative electrode over the life of the electrode and any amount of the solid-state additive that is lost from the iron negative electrode may result in decreasing performance over the life of the given iron negative electrode and/or result in increased cost to compensate for the loss of the solid-state additive.

Several factors affect floataway/fallout risk of solid state additives. A first factor that affects floataway/fallout risk is particle size. While it is generally lowest cost to procure the solid-state additives in small sizes (e.g. 5 microns), interactions of solid-state additives with bubbles can be severe at these length scales. Additionally, or instead, a porosity of an iron negative electrode itself may act like a “filter” for a solid-state additive if the particle size of the discrete granules 208 of the at least one metal sulfide is on the order of the pore size of the iron negative electrode 14 or greater than the pore size of the iron negative electrode 14. Although capillary interactions may be tuned with surface chemistry, viscous drag forces are fundamental to bubble passage through the iron negative electrode and may cause particles of the solid-state additive to be lost regardless of the surface chemistry of the particles of the solid-state additive. A second factor that affects floataway/fallout risk is surface chemistry. Additives that have a non-polar surface or low surface energies will tend to adsorb more strongly to the surface of bubbles and therefore experience enhanced drag from the bubbles.

Accordingly, as compared to the use of a powder of loose particles of a solid-state additive, the second powder 206 of discrete granules 208 including the agglomerated particles 210 of the solid-state additive may mitigate the risk of losing particles of solid-state additive material. That is, discrete granules 208 of the agglomerated particles 210 are significantly larger than each of the individual particles and, therefore, may be more resistant to drag forces by bubbles or other forces acting to remove the solid-state additive from the iron negative electrode 14. Further, or instead, because the size of the discrete granules 208 of the agglomerated particles 210 are decoupled from the size of the individual particles, the size of the discrete granules 208 may be chosen such that the discrete granules 208 do not “fit” through the porosity of the iron negative electrode 14. As an example, the iron negative electrode 12 may be modeled as a packed bed filter, through which hydrogen bubbles and electrolyte move/flow, exerting accompanying viscous and capillary drag forces. The discrete granules 208 with sizes on the order of the pore size of the iron negative electrode 14 may be geometrically prevented from migrating out of the iron negative electrode, thus maintaining the solid state additive at a desired position in the iron negative electrode 14. Accordingly, in some implementations, the mean particle size of the discrete granules 208 is greater than or equal to the mean pore size of the powder blend 202, such as may be useful for reducing floataway/fallout risk of the solid-state additive from the iron negative electrode 14. Further, or instead, in packed bed filters, good filtration often occurs if the filter pore size is within a factor of 4 of the particle sizes to be filtered. Thus, in some instances, the discrete granules 208 may have a mean particle size that is less than the mean pore size of the powder blend 202 of the iron negative electrode and, in such instances, the discrete granules 208 may be adequately retained within the iron negative electrode 14.

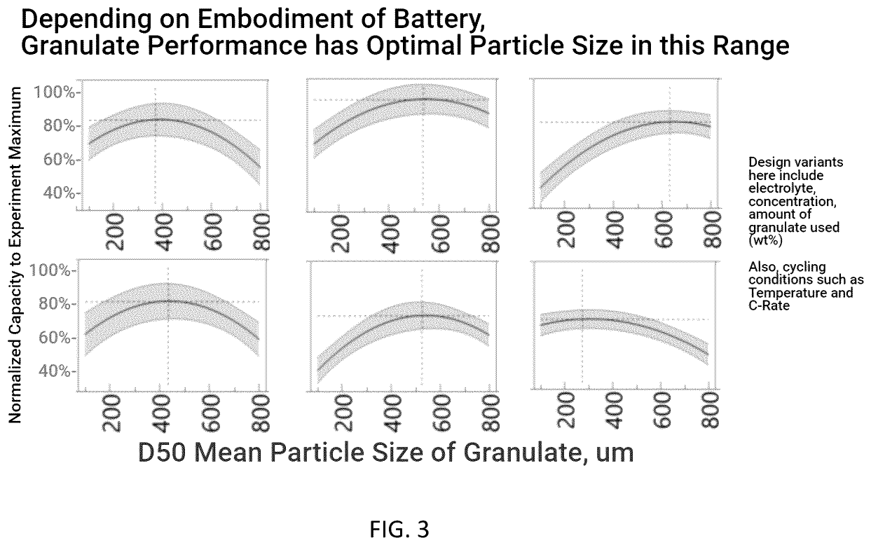

Referring now to FIG. 1B, FIGS. 2A and 2B, and FIG. 3, while larger average sizes of the discrete granules 208 may be generally useful for addressing floataway/fallout risk, it has been experimentally determined that the average size of the discrete granules 208 may impact capacity of the iron negative electrode 14. In particular, as shown in the experimental results in FIG. 3, the capacity performance of the iron negative electrode 14 increases with increasing mean particle size of the discrete granules 208 up to some optimal capacity and then decreases with further increases in the mean particle size of the discrete granules 208. Stated differently, the mitigation of the floataway/fallout risk based on the size of the discrete granules 208 may be range bound by the impact of the size of the discrete granules 208 on the capacity of the iron negative electrode 14. In particular, based on these experimental results, the discrete granules 208 have a mean particle size greater than about 30 microns and less than about 800 microns on a weight percentage basis, as determined by laser diffraction particle size analysis. This range is useful for balancing competing sizing considerations of mitigating floataway/fallout risk relative to achieving peak capacity of the iron negative electrode 14.

In some implementations, floataway/fallout risk may be additionally or alternatively mitigated by generating bubbles in the iron negative electrode 14 away from the second powder 206 of the discrete granules 208 including the agglomerated particles 210. For example, concentration of the second powder 206 in the powder blend 202 may have a predetermined gradient along a thickness dimension of the active layer strata of the iron negative electrode 14 (corresponding to the thickness of the powder blend 202 in FIG. 2A). Thus, with such a gradient in the active layer strata of the iron negative electrode, hydrogen evolution in the iron negative electrode 14 may take place away from the location of the second powder 206 such that its floataway/fallout risk is minimized.

In general, the first powder 204 of the powder blend 202 in the iron negative electrode 14 may include any one or more types of iron active material suitable for use in any one or more of the various different electrochemical cells described herein. For example, the iron active material of the first powder 204 may include one or more iron-bearing compounds, which may be in any one or more of various different shapes (e.g., pelletized, briquetted, pressed, or sintered) in the first powder 204. The one or more iron-bearing compounds may range from highly reduced forms of iron (more metallic) to highly oxidized forms of iron (more ionic). Thus, for example, the one or more iron-bearing compounds may include an iron-containing alloy or an iron-containing compound, such as an iron oxide, iron mixed oxide, iron hydroxide, iron sulphate, iron carbonate, iron sulfide, or any combination of thesc. Additionally, or alternatively, the one or more iron-bearing compounds may include purified or refined iron materials such as carbonyl iron or electrolytic iron, or iron ores such as magnetite, maghemite, iron carbonate, hematite, goethite, limonite, or other iron materials. In certain implementations, the iron active material of the first powder 204 may include one or more of an iron oxide, an atomized iron powder, iron sponge powder, a milled iron powder, other additives including conductive carbon additives, or any combination of these.

In general, the second powder 206 in the powder blend 202 with the first powder 204 may facilitate forming the iron negative electrode 14 through dry material filling. As an example, the powder blend 202 may be added to a die, the powder blend 202 may be pressed to form the iron negative electrode 14. According to this and other fabrication techniques, the apparent density of the powder blend 202 may be less than the apparent density of the first powder blend 202 alone under otherwise similar compression. That is, the powder blend 202 may facilitate forming the iron negative electrode 14 as a low density/high porosity electrode, as compared to an iron negative electrode formed without the second powder 206. Such low density/high porosity may, for example, facilitate exposing more of the iron active material of the first powder 204 to an electrolyte, thus improving performance of the iron negative electrode 14.

The size of the iron active material of the first powder 204 relative to the size of the discrete granules 208 may be tuned to facilitate dry powder processing to form the iron active electrode 14 and/or to achieve target porosity of the iron active electrode 14. To reduce the likelihood of unintended separation of the second powder 206 from the first powder 204 in the powder blend 202, the discrete granules 208 of the second powder 206 and the iron active material of the second powder may have similar particle sizes such that the first powder 204 and the second powder 206 have similar flow characteristics. The average particle size of the discrete granules 208 that minimizes segregation from the first powder 204 may be close to, but not necessarily identical to, the average particle size of the first powder 204. The matching—or near matching—of the average particle size of the discrete granules 208 to the average particle size of the first powder 204 may remove the solid-state particles of the at least one metal sulfide from the interstitial spaces between the particles of the iron active material of the first powder 204. As an example, a ratio of the mean particle size of the discrete granules 208 of the second powder 206 to the mean particle size of particles of the iron active material of the first powder 204 may be 0.5 to 2. With this relative sizing, the first powder 204 and the second powder 206 may generally flow together during dry material filling while also increasing the porosity of the iron negative electrode to facilitate better ionic transport/rate capability of the iron negative electrode 14.

In certain implementations, the at least one metal sulfide of the agglomerated particles 210 may be greater than 50 wt % (e.g., greater than 80 wt %) of the discrete granules 208. That is, the agglomerated particles 210 may be mostly formed of the at least one metal sulfide such that the agglomerated particles 210 do not take up significantly more volume than is useful for acting as an additive in the iron negative electrode 14. As described in greater detail below, techniques for agglomerating particles of the at least one metal sulfide to form the agglomerated particles 210 may be carried out without the use of binders or through efficient use of binders.

While the powder blend 202 in the iron negative electrode 14 has porosity defined by the first powder 204 and the second powder 206, it shall be appreciated that the discrete granules 208 may contribute to the overall porosity of the powder blend 202 via porosity of the discrete granules 208 themselves. For example, the discrete granules 208 of the agglomerated particles 210 of the at least one metal sulfide may have a median pore size of greater than about 75 nanometers and less than about 15 microns, as determined by mercury intrusion porosimetry. Thus, more generally, the discrete granules 208 may have a first average apparent density, the particles that form the agglomerated particles 210 include a second average apparent density, and the first average apparent density is less than the second average apparent density. As an example, the first average apparent density may be greater than 1.0 grams per cubic centimeter and less than 2.1 grams per cubic centimeter. The lower apparent density of the discrete granules 208 relative to the apparent density of the particles forming the agglomerated particles 210 may facilitate exposing a large amount of surface area of the at least one metal sulfide to an electrolyte in an electrochemical cell. In some instances, the agglomerated particles 210 of the discrete granules 208 may have surface-connected porosity to facilitate cost-effective fabrication of the discrete granules 208 while also facilitating exposing a large amount of surface area of the at least one metal sulfide to an electrolyte in an electrochemical cell. As an example, the surface-connected porosity of the discrete granules 208 may be greater than or equal to 7 vol. % and less than or equal to 40 vol. % of the agglomerated particles 210, as determined by mercury intrusion porosimetry.

In certain implementations, the at least one metal sulfide of the agglomerated particles 210 may include zinc sulfide (ZnS), as may be useful for improving capacity of the iron negative electrode 14 relative to a similar electrode without the zinc sulfide. To achieve such improvement in performance of the iron negative electrode 14 with volumetric efficiency in the size of the discrete granules 208, the second powder 206 of the discrete granules 208 may be greater than or equal to 90% by weight zinc sulfide. In some implementations, the zinc sulfide may be in the lower-temperature sphalerite structure (e.g., greater than 60% by weight of the zinc sulfide may be in the lower-temperature sphalerite structure), as determined by x-ray diffraction. As described in greater detail below, the lower temperature sphalerite structure of zinc sulfide may be useful for certain types of agglomeration (e.g., sintering) that may be used to form the agglomerated particles 210 in instances in which the at least one metal sulfide includes zinc sulfide.

While the at least one metal sulfide of the agglomerated particles 210 has been described as including zinc sulfide, it shall be appreciated that any one or more other types of metal sulfides may be additionally or alternatively included in the agglomerated particles 210. For example, the one or more metal sulfides of the discrete granules 208 may additionally or alternatively include any one or more of iron sulfide (e.g., FeS, Fe₃S₄, Fe₂S₃ and/or other forms), tin sulfide (SnS), bismuth sulfide (Bi₂S₃), aluminum sulfide (Al₂S₃), antimony(III) sulfide (Sb₂S₃), antimony(V) sulfide (Sb₂S₅), manganese sulfide (MnS), molybdenum(IV) sulfide (MoS₂), iron disulfide, iron-copper sulfide, tin sulfide, copper sulfide, cadmium sulfide, silver sulfide, titanium disulfide, lead sulfide, nickel sulfide, antimony sulfide, including polymorphs of these. In some instances, the discrete granules 208 may further include suboxides of a metal sulfide, or a solid solution of a metal sulfide and an oxide or hydroxide. In certain instances, the discrete granules 208 may further include minerals such as a sulfosalt mineral, which is a salt of a metal (e.g., Cu, Pb, Ag, Fe, Hg, Zn, V), a semi-metal (e.g., As, Sb, Bi, Ge) and sulfur. Example sulfosalts include Pyrargyrite Ag₃SbS₃ and Tennantite Cu₁₂As₄S₁₃. In some cases (e.g., depending on an electrolyte composition or other factors), the discrete granules 208 may additionally include a non-metal sulfide compound. Further, or instead, the discrete granules 208 may further include include tin oxide (SnO₂), tin (Sn), bismuth (Bi), iron selenide (FeSe), tin selenide (SnSe), zinc selenide (ZnSe), potassium hydroxide (KOH), sodium hydroxide (NaOH), or combinations thereof.

In some implementations, the discrete granules 208 may further include particles of a pore former 212 to impart strength to the discrete granules 208, even as the discrete granules 208 are porous. The mean size of the particles of the pore former 212 may be selected based on geometric considerations related to the initial size of the particles of the at least one metal sulfide forming the agglomerated particles 210 and geometric considerations related to the final intended size of the discrete granules 208 after the particles of the at least one metal sulfide form the agglomerated particles 210. Generally, effective pore forming may occur when the mean particle size of the pore former 212 may be significantly less than the mean particle size of the discrete granules 208, and the same size or larger than the mean particle size of the particles of the at least one metal sulfide forming the agglomerated particles 210. For example, with a ˜5 micron mean particle size of the particles that are agglomerated to form the agglomerated particles 210 and a 100 micron mean particle size of the discrete granules 208, the mean particle size of the pore former 212 may be greater than about 5 microns and less than about 20 microns on a weight percentage basis. Further, or instead, the particles forming the agglomerated particles 210 of the at least one metal sulfide may have a first mean particle size on a weight percentage basis, the particles of the pore former 212 may have a second mean particle size on a weight percentage basis, and the second mean particle size may be greater than or equal to the first mean particle size. That is, the pore former 212 may be sized to impart more porosity to the discrete granules 208 of the second powder 206 than may be achievable using only the particles forming the agglomerated particles 210. Further, or instead, the particles of the pore former 212 may be soluble in an alkaline electrolyte such that the particles of the pore former 212 dissolve (e.g., quickly or over time) and leave behind porosity in the powder blend 202 of the iron negative electrode 14.

The particles of the pore former 212 may include any one or more different types of materials useful as spaceholders that are low cost and easy to remove. As an example, the particles of the pore former 212 may include potassium oxide (K₂O), lithium oxide (LiO), sodium oxide (Na₂O), potassium hydroxide (KOH), lithium hydroxide (LiOH), sodium hydroxide (NaOH), sodium sulfate (Na₂S), potassium sulfate (K₂S), sodium carbonate (Na₂CO₃), potassium carbonate (K₂CO₃), sodium stannate (Na₂[Sn(OH)₆]), potassium stannate (K₂[Sn(OH)₆]), or combinations thereof. A subset of these materials, including KOH, NaOH, Na₂CO₃, K₂CO₃ may usefully thermally dissociate to a constituent salt and a gaseous byproduct (e.g. 2 KOH+heat→K₂O+H₂O or K₂CO₃+heat→K₂O+CO₂). Production of a gaseous byproduct is useful in that the placeholder is higher volume but low in cost. Further, or instead, the particles of the pore former 212 may include poly(methyl methacrylate), starch, sodium chloride (NaCl), potassium chloride (KCl), ammonium bicarbonate (NH₄HCO₃), or a combination thereof.

In general, referring now to FIGS. 2A-2C, the second powder 206 of the discrete granules 208 should generally be able to be blended and handled with the first powder 204 without disintegrating or otherwise losing its intended size. Disintegration or partial disintegration may be defined as when the solid state additive secondary particles are significantly reduced in size following blending and handling. A significant size reduction may be defined as a measurable shift in particle size distribution to lower particle sizes, including a formation of a measurable ‘second mode’ of the particle size distribution (resulting from the formation of smaller particles through disintegration) that is on the order of the primary particle size.

Disintegration may also be identified by microscopy. For example, the other powders in the blend may be imaged before blending versus after blending, and the surfaces of the other powders may be inspected to understand if parts of the solid additive material are deposited on the surface. Additionally, or alternatively, solid additives may be shown to not disintegrate in blending by monitoring particle shape of the secondary particles throughout the blending process. If the particles are shown to round out or otherwise change shape throughout blending, the particles are at least partially disintegrating during the blending process.

The resistance to disintegration may be quantified as the friability of the second powder 206 of discrete granules 208 according to European Pharmacopoeia 2.9.41.-2 (Method B), the entire contents of which are hereby incorporated herein by reference. The test procedure may be tuned for different materials to discriminate between granules that are not suitable for use as battery additives and granules that are suitable for use as battery additives. In one implementation, the friability of ZnS-based granules was defined. Shaking in a friability tester at a frequency of 400 oscillations per minute for 240 seconds and 10±1 gram of material in the tester vial demonstrated significant fines generation from high friability materials, in an amount that is considered unacceptable for use in the second powder 206. In particular, per the procedure outlined below, a friability of 20% was observed. Friability of less than about 15% (e.g., less than 10%, less than 5%) is acceptable for use in the second powder 206, with small variations allowable for testing tolerances. The starting material was a powder with a particle size of 150-500 microns. Due to the finer particle size, of the starting material, a dry particle size analyzer (Camsizer X2 with 30 kPa dispersion pressure) was used to take a particle size distribution from the material and quantify the difference in the particle size distribution before and after the material was shaken in the friability tester. A second mode was found in the particle size distribution at finer particle sizes after shaking in the friability tester; this was interpreted as originating from particle breakdown.

The amount of material attributed to this mode was quantified by:
1) Plotting q3 (the derivative of the cumulative particle size distribution) as a function of particle size for both the powder before shaking in the friability tester and the powder after shaking in the friability tester.
2) If the material is sufficiently low friability, the particle size distributions before and after shaking in the friability tester should have a substantially similar particle size distribution, with the modes in the particle size distribution having roughly the same particle size as before shaking, and the possible addition of a new mode at finer particle sizes—this new mode at finer particle sizes is designated the fines mode. In the case where modes in the particle size distribution do not occur at approximately the same particle sizes before and after shaking in the friability tester, the material is too friable because it has disintegrated in the tester. These materials are defined as having a higher friability than the desired level, even if a precise value cannot be computed.
3) From comparing the particle size distributions before and after shaking in the friability tester, a particle size may be selected that separates the fines mode from the original mode(s) in the particle size distribution. This is usually chosen as the local minimum in q3 as a function of particle size. This particle size is called the cutoff size.

As a quantitative metric, friability of less than about 10% weight loss of the original sample as fines according to European Pharmacopoeia 2.9.41.-2 (Method B) may represent suitable resistance to disintegration useful for using the second powder 206 reliably through handling to form the iron negative electrode 14 and in use in the iron negative electrode 14.

FIG. 2C is an image showing a powder of discrete granules (e.g., the second powder 206 of the discrete granules 208 in FIGS. 2A and 2B) mixed with a powder of iron active material (e.g., the first powder 204 in FIGS. 2A and 2B). In the image, the powder of the discrete granules is light colored, and the powder of iron active material is dark colored. In this example, solid state additive (ZnS) was granulated with poly(vinyl alcohol) and carboxymethylcellulose. Both binders worked to produce agglomerates. The process resulted in particles with sizes similar to iron active material in some cases. Incorporating these materials into Fe electrode powder mixes successfully lowered the apparent density of the powder mix, proving that electrode porosity may be preserved. Proof of concept sintering of ZnS was performed and generated materials with appropriate strength and performance, as well. These additives were incorporated into electrochemical tests and showed enhanced performance.

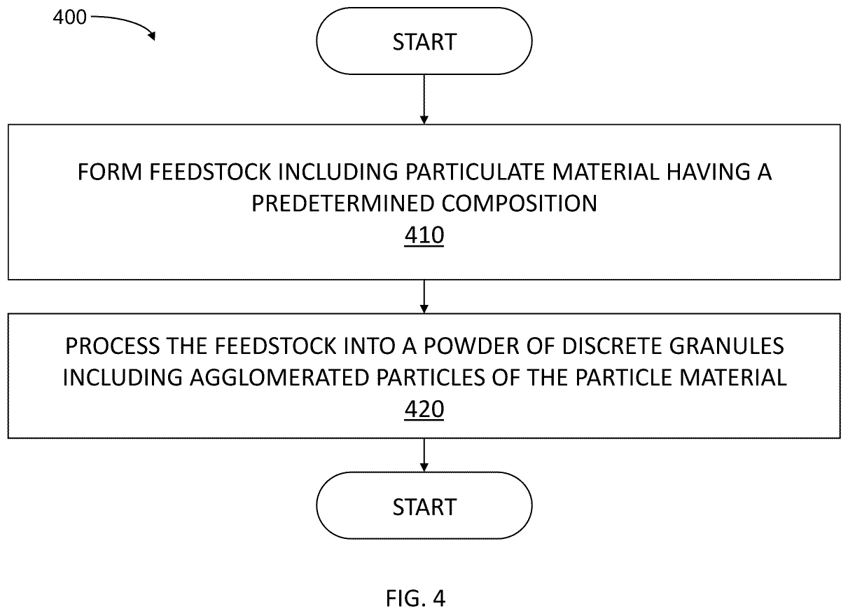

FIG. 4 is a flowchart of an exemplary method 400 of making an additive for an iron negative electrode of an alkaline electrochemical cell. Unless otherwise specified or made clear from the context, any one or more aspects of the exemplary method 400 may be used to make the second powder 206 (FIGS. 2A and 2B) for the iron negative electrode 14 (FIGS. 1B and 2A) of the rechargeable battery 10 (FIG. 1B).

As shown in step 410, the exemplary method 400 may include forming a feedstock including a particulate material having a predetermined composition. The particulate material shall be understood to refer to the loose particles of material that are agglomerated together to form any one or more of the agglomerated particles 210 (FIG. 2B). Thus, the particulate material may include particles of the at least one metal sulfide prior to agglomeration into the agglomerated particles. By way of example and not limitation, the particles of the at least one metal sulfide may include particles of zinc sulfide (ZnS).

In some implementations, the particulate material of the feedstock may include a combination of a plurality of types particles of solid-state additives with varying chemistry and/or particle size. As an example, to facilitate achieving best performance in an electrochemical cell, it may be useful to mix the plurality of types of particles substantially uniformly with the iron active particles of any one or more of the powder blends described herein. Mixing a plurality of types of particles of solid state additives in the feedstock in a predetermined weight ratio relative to one another prior to processing may facilitate achieving such substantial uniformity in the powder blend to be formed subsequently through processing with the iron active particles. That is, for any two additives, A and B, particulate material of only A and only B will inevitably result in A-rich pockets and B-rich pockets, whereas particulate material of the appropriate mixture of A+B will generally lead to the better uniformity in the distribution of both of the additives A and B. As an example, the feedstock of the particulate material may include mixing at least two metal sulfides (e.g., zinc sulfide and iron sulfide). In some implementations, particulate material of the at least two sulfides may be mixed together in a predetermined weight ratio relative to one another. This weight ratio may advantageously persist through processing of the feedstock to form the discrete granules such that the discrete granules may have a predetermined weight ratio of the at least two metal sulfides.

In some implementations, forming the feedstock including particulate material having a predetermined composition may include blending particles of a pore former (e.g., any one or more of the various different pore formers described herein) with the particles of the at least one metal sulfide. In some instances, the pore former may be soluble in alkaline electrolyte. A ratio of the mean particle size of the particles of the pore former to the mean particle size of the particles of the at least one metal sulfide in the feedstock may be greater than or equal to 1:1 and less than about 5:1.

In some implementations, forming the feedstock may include mixing an electrically conductive material with the at least one metal sulfide. The electrically conductive material may include tin, graphite, carbon black, or a combination thereof. In instances in which the feedstock includes the electrically conductive material, it shall be appreciated that the discrete granules produced through any one or more of the processing techniques described below may include electrically conductive material.

In the specific case of iron negative electrodes incorporating solid state additives, the size of the particles of the iron active material may be between around 50 and around 900 microns, and the size of the particulate material at least one metal sulfide may often be around 10 microns or below. This is for several reasons: 1) many solid state additives are produced for battery applications via chemical synthesis and related techniques that are often highest-yield and lowest-cost when producing particles with sizes between ˜500 nm and 10 μm; 2) the action of the additives may rely on a uniform and fine dispersion throughout the iron negative electrode to enhance electrode performance; or 3) the additives may require a high surface area to enhance electrode performance. The size of particulate material of one or more additives may be influenced by one or more of these reasons. Some examples of additives that are most effective using particulate material having particle size that is finer than the iron particle size in the iron negative electrode include MnS, Al₂S₃, Sb₂S₃, Sb₂S₅, FeS, BizS₃, MoS₂, conducting additives like graphite or carbon blacks, tin-containing solid compounds, and ZnS.

In some implementations, forming the feedstock may include introducing at least at least one polymeric binder to the particulate material. As described in greater detail below, the at least one polymeric binder may be used as part of a sintering process such that the agglomerated particles formed from the particulate material of the feedstock are solid-state bonded together.

As shown in step 420, the exemplary method 400 may include processing the feedstock including the particulate material into a powder of discrete granules including agglomerated particles of the particulate material, the agglomerated particles including at least one metal sulfide. As described in greater detail below, processing the feedstock including the particulate material into the powder of discrete granules may include any one or more of various different granulation techniques that may be cost-effectively implemented to produce the powder of discrete granules with target friability for achieving performance targets of iron negative electrodes formed using the powder of discrete granules.

In some implementations, the particulate material of the feedstock may be bonded together in the solid state to form the discrete granules of agglomerated particles. For example, such solid state bonding may include bonding the material in the solid state with bonds of the same material. Solid state bonding may be carried out according to any one or more of various different techniques. However, solid state bonding formed according to such techniques may be defined by the presence of a neck or solid state contact between the agglomerated particles (which can be observed, for example, via microscopy of the agglomerated particles surfaces and/or in cross section), including the case where the neck or bond size is >5% of the of the particle diameter. Further, or instead, solid state bonding may be characterized by processing material through any one or more processes that result in significant increases in the strength of the material undergoing the process, provided the increases in strength are attributable to solid state bonds. Examples of processes that can be used to form solid state bonds include sintering (including sintering above half of the material's melting temperature), hot pressing (including hot pressing at or above 30% of the material's melting temperature), cold sintering, infiltration, and reaction bonding. Equipment to perform solid state bonding may include calciners, continuous linear furnaces (e.g. belt, pushers, and walking beam furnaces), and/or batch furnaces.

As an example, the particulate material of the feedstock may be solid-state bonded between about 500 degrees Celsius and about 1400 degrees Celsius. This solid-state bonding may occur in non-oxidizing atmospheres, such as reducing, or inert atmospheres. In instances in which the at least one metal sulfide includes zinc sulfide, oxidizing atmospheres may be less desirable due to the potential for formation of hazardous sulfur dioxide and sulfur oxide gasses and a lessening of the ZnS content by forming ZnO from the ZnS. Inert atmospheres may include nitrogen or argon. Reducing atmospheres may include hydrogen or carbon monoxide. Mixtures of these atmospheres may be used (e.g., a combination of nitrogen and hydrogen). Satisfactory sintering has been experimentally observed to be possible at temperatures of at a temperature greater than 900 degrees C. and less than 1300° C. (e.g., ˜1100° C.) for fine ZnS particulate material, and hot pressing has been shown to be satisfactory for fine ZnS powders at 900° C. and uniaxial pressures around 60 psi (about 410 kPa), and times of around 10 minutes. The sintering and/or hot pressing temperature, pressure, and other processing conditions will be a function of the material used and density desired.

In certain implementations, processing the feedstock into the discrete granules may include introducing at least one binder to the discrete granules of the agglomerated particles. Continuing with this example, the at least one binder introduced into the discrete granules may be soluble and/or reactive to form a soluble species in an alkaline electrolyte such that the binder may bond the particulate material into the discrete granules of agglomerated particles to facilitate handling the powder of the discrete granules to form the iron negative electrode and the binder may dissolve in the iron negative electrode as the rechargeable battery cycles.

Returning to the example in which forming the feedstock includes introducing at least one polymeric binder to the particulate material, processing the feedstock into the discrete granules may include pyrolyzing the at least one polymeric binder to form a graphitized film on the particulate material. The type of binder used may be a function of the material being bound, and how the electrodes are being processed. In the case of ZnS agglomeration, the at least one binder may include CMC, poly(vinyl alcohol), and poly(ethylene glycol). The at least one binder and subsequent processing may be chosen such that the binder retains the solid additive within the powder bed during electrochemical cycling, and particularly such that small particles are bound in place during electrochemical cycling. A binder that pyrolyzes with a high amount of char during high temperature processing (e.g. sintering, hot pressing) may result in discrete granules of the agglomerated particles that maintain the particles within the discrete granules/mitigate risks of particle floataway. High char binders may be defined as binders that pyrolyze in inert atmosphere with >7 wt % yield of residual solids after pyrolysis in non-oxidizing atmosphere up to 600° C. Carboxymethylcellulose (CMC) or poly(acrylic acid) may be used as a high char binder. Polyacrylonitrile (PAN) or other polymers with aromatic rings may be used as high char binder systems. In such cases, the act of pyrolysis may simultaneously be used to graphitize the char, thereby producing a strong, coherent, graphitized film on the solid state additive which retains the additive. Pitch may be used as a binder or co-binder. In many instances, a mixture of binders may be used for the granulation process. These binders may serve different uses. For example, poly(vinyl alcohol) may be used in combination with CMC and/or PAN to customize the rheology, granulate strength, and char levels of the granulate. In some embodiments, the binder may be retained in the discrete granulates through the life of the electro chemical cell. In such instances, the binder may be compatible with alkaline electrolytes and, thus, may include poly(tetrafluoroethylene), carboxymethylcellulose, poly(ethylene), poly(propylene), and polyvinylidene fluoride. In some instances, binder pyrolysis and residual char may be detrimental to the solid state additives and a lower-char binder may be desired. In such cases poly(ethylene), poly(propylene), poly(vinyl alcohol), or other binders that yield low residual carbon may be usefully used to form the discrete granules of agglomerated particles. In some implementations, an inorganic binder may be used such as a clay or silicate-based binder, an alumina-containing binder, or any other oxide-based binder common in the art for binding powdered materials together.

In certain implementations, techniques for processing the feedstock to form the discrete granules of agglomerated particles may include granulation processes that do not involve a binder. Such processes may include compaction (e.g., roller compaction) or sintering of powdered bodies and reducing the sintered body to an appropriate size via e.g. crushing.

Processing the feedstock to form the discrete granules may additionally or alternatively include any of the following, or any other suitable granulation techniques that may be useful for bonding smaller powder particles together into coarser powder particles: fluid bed granulation; spray drying; high shear mixer granulation; twin screw granulation; roller compaction; intensive mixing; moist granulation and extrusion-granulation; and open pan/disc pelletizing.

In some cases, combinations of the any one or more of the granulation techniques described herein may be used. For example, sometimes more strength may be desired than can be reasonably achieved via granulation with binders, but tight particle sizes and high sphericity may also be desired. In such cases, a spray drying technique may be used to agglomerate the particulate material, and the resulting material may be subsequently sintered in a process known as an agglomeration and sintering process.

In some cases, the interparticle attractive forces may be sufficient that a binder is not needed to form the discrete granules of agglomerated particles. For example, nanometer-sized powders may be agglomerated without the need for binders.

In some implementations, processing the feedstock to form the discrete granules of agglomerated particles may include binder-based granulation, including drum granulation, spray drying, wet or dry granulation.

In some cases, an additive may serve as a binder for other additives. For example, a first additive may be heated in the presence of a second low-melting additive that solidifies when cooled to room temperature. For example, the first additive may be FeS or ZnS, and the second additive may be Sn. The heating may take place in an inert atmosphere to prevent oxidation of the molten phase. The crystallography and chemistry of both the first and second additives may be tuned to assure wetting of the first additive by the second additive and, thus, assure homogeneous bonding and high strength upon cooling. The resulting material may be considered a metal-matrix composite that is bonded through infiltration. Incorporating the bonding/infiltrating second additive as a powder during the infiltration process result in a higher degree of homogeneity in the material properties of the resultant discrete granules and may creates more porosity in the discrete granules, thus usefully increasing the rate capability and/or lowering the impedance of resultant iron negative electrodes formed using the powder of discrete granules.

In some implementations, the particulate material of the feedstock may be solid state bonded in a form factor that is close to the desired size and shape. For example, already-agglomerated powder may be solid state bonded through many of the techniques known in the art for agglomeration and/or sintering of powders. As a specific example, a ZnS powder may be briquetted and, in some cases, ground to the desired size distribution, and then the resulting agglomerates may be sintered (e.g. in a continuous sintering furnace). In certain instances, a ZnS powder may be spray dried to form agglomerates in the appropriate size range, and the resulting agglomerates may then be sintered. The resultant sintered material may be lightly milled in a rod mill or similar to break up any light bonding between the secondary particles that occurred during the sintering step without further breaking down the discrete granules of agglomerated particles.

In certain implementations, the feedstock may be cold pressed together to form the discrete granules, and the discrete granules may maintain sufficient adhesion for handling, such as in the case of cold pressing of tin powders, or various briquetting techniques for ceramic powders.

Using any one or more of the various different techniques described herein, the bonding/granulation process may result in bonded material particles larger than the desired average particle size of the powder of the discrete granules (e.g., having at least one dimension on the order of 1 mm or larger). In such instances, the resulting bonded/sintered compacts may be intermediate bodies that may be mechanically processed (e.g., through appropriate crushing, milling, grinding, and sizing/sieving techniques) to achieve the target average particle size of the powder of discrete granules. Such processing usefully separates the bonding process from the sizing process, thus facilitating wider process windows and material combinations.

In some implementations, the feedstock may be processed as larger, monolithic blocks of ceramic material (by, e.g., pressing and sintering of geometries having at least at least one dimension on the order of 1 mm or larger). The resulting larger-scale solid state bonded material may then be crushed, ground, or otherwise size reduced to produce the discrete granulates of the desired size.

In some implementations, an alloying element may be included which expands the stability of the ZnS cubic phase to higher temperatures, thereby preserving the cubic phase during a thermal processing operation or aiding in the conversion of the hexagonal phase to the cubic phase.

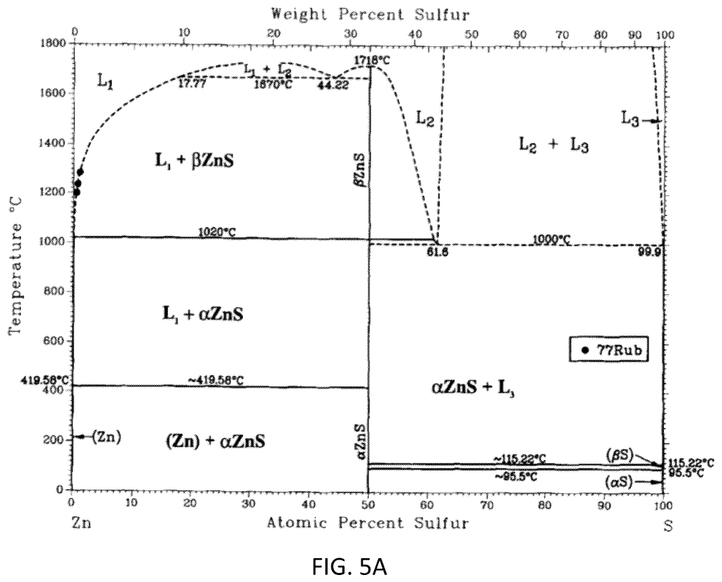

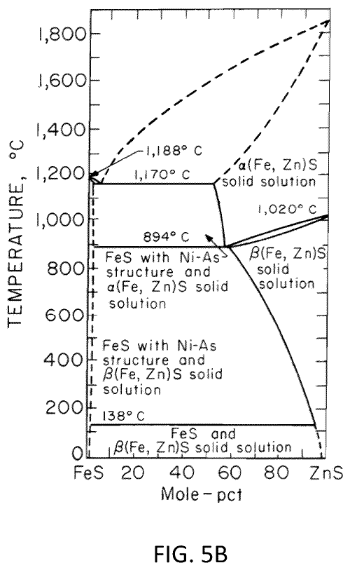

Referring now to FIG. 4 and FIGS. 5A and 5B are ZnS phase diagrams showing phase behavior as functions of temperature and composition. The phase diagrams illustrate the solubility of FeS in ZnS and that doping with FeS can usefully manipulate the phase transition temperature. It may be noted that Fe is soluble in ZnS up to ˜40 mol %. In some embodiments, it may be useful to have the ZnS in the lower-temperature sphalerite structure. Iron depresses the sphalerite to wurtzite phase transition temperature, making the ZnS convert to wurtzite crystal structures more readily. Relatedly, contamination with iron suppresses the reconversion of the wurzite structure to the sphalerite structure. This transition can be sluggish relative to timescales that are relevant to industrial processing (10's of minutes to hours). The lowering of the phase transition temperature, creation of chemical partitioning and drag effects, and the attendant sluggish diffusion kinetics at lower temperatures combine to make the phase transition slow upon introduction of Fe alloying elements.

In instances in which the at least one metal sulfide includes ZnS, the cubic ZnS phase may be preserved during thermal processing. For example, in such instances, the feedstock may be sintered above the sphalerite ZnS/wurtzite ZnS phase transition temperature (1020° ° C. for pure ZnS) and annealed below the sphalerite ZnS/wurtzite ZnS phase transition temperature during cooling to encourage the transition back to sphalerite ZnS. Annealing to transition to sphalerite ZnS may need to carefully balance kinetics and driving force for the transformation to get the transition to occur on a useful timescale (10's of minutes to hours). Generally, the driving force for conversion to the cubic phase increases with increasing undercooling below the phase transition temperature, but kinetics for the transformation are somewhat slow. Annealing conditions to achieve conversion of the wurtzite structure to the sphalerite structure may be between about 700° C. and about 1000° C. (e.g., between about 800° C. and about 950° C.) for timescales between about 15 minutes and about 4 hours. In some instances, the thermal exposure may include an isothermal hold in the temperature ranges listed. The cooling of the material may be intentionally implemented to be slow enough in the temperature ranges listed that the conversion in crystal structures occurs. In some implementations, a combination of slow cooling and isothermal holds may be used to achieve conversion of the crystal structures. In certain cases, the material may be re-heated to achieve conversion to the cubic phase of the ZnS material (as opposed to doing the solid state bonding and crystal structure conversion in one step).

Continuing with this example, sintering may usefully occur below the sphalerite ZnS/wurtzite ZnS phase transition temperature to create a sintered granulate with the sphalerite ZnS crystal structure without the need for further processing to convert the ZnS to sphalerite structure, thus saving costly processing time and energy.

In some implementations, processing the feedstock to form the discrete granules may include management of C and O impurities.

As an example, ZnO and C-based impurities may not be desired in the ZnS additives. ZnO, if left in the discrete granules, may either be reduced in subsequent thermal processing or dissolved to form zincate ions when the discrete granules of the agglomerated particles enter the electrolyte. Reduction may lead to evaporation of metallic Zn and subsequent deposition in the thermal processing equipment. Alternatively, if the ZnO enters an electrochemical cell, it may dissolve in the alkaline electrolyte of the electrochemical cell resulting in potential impacts on electrochemical performance. Thus, both reduction and dissolution may be undesirable.

Thus, continuing with this example, a reducing and/or decarburizing atmosphere may be used to remove the ZnO in a controlled manner. ZnO reduction usually takes place between 700° C. and 1000° C., resulting in gaseous Zn metal and an oxidized reducing species. In various embodiments, reductions may be performed with a reductant such as solid state carbon, gaseous carbon monoxide, or gaseous hydrogen.

In certain implementations, the likelihood of ZnO evaporation may be reduced using S-containing gases. ZnS often contains trace ZnO, and ZnS may react with O in the processing atmosphere to yield ZnO. ZnO may be reduced to form Zn-based vapors, especially during high temperature electrode processing. Zn evaporation can be harmful to thermal processing equipment, and so it is desirable to avoid or at least reduce the likelihood of this possibility. Thus, in some implementations, a sulfur-containing gas may be added to increase the sulfur potential in the processing atmosphere. The ZnO may be converted to ZnS, and evaporation of Zn prevented. The gas may be chosen to be a reducing gas. As examples, the sulfur-containing gases may be any one or combination of: 1) hydrogen sulfide, H₂S; 2) carbonyl sulfide, OCS; 3) methane thiol, CH₃SH; and/or 4) sulfur dioxide, SO₂.

In some implementations, the impact of gaseous zinc formation on electrode formation and/or furnace operation may be reduced. In the presence of a carbon source, the concomitant presence of oxides (e.g., ZnO) in zinc sulfide sources or formation of zinc oxide on otherwise oxide-free surfaces through oxidation may lead to the carbothermic reduction of ZnO to Zn(g) when heated to temperatures in excess of 800° C. The formation of this gaseous zinc may be controlled to prevent or at least reduce the likelihood of interference with furnace operation or electrode fabrication. Carbothermic reduction may include each of the following: 1) both carbon and zinc oxide present in the electrode being heated; and 2) sufficiently high temperatures. As a result, preventing or controlling gaseous zinc formation by a zinc source containing any amount of zinc oxide may require removing one of the preceding factors. In one implementation, the particulate material may include zinc sulfide, an iron source, and some source of carbon and these may be compacted at temperatures around about 750° C., about 750-800° C., about 800° C., about 800-850° C., or about 850° C. to reduce the likelihood of excess zinc oxide reduction.

As an additional or alternative example, C-based contamination in the ZnS may be undesirable. It has been found that C contamination may enhance undesirable side reactions when processing ZnS with Fe at elevated temperatures. Management of C may take place through 3 routes in various embodiments: 1) minimizing or eliminating the use of binders or other carbon-containing materials in processing; 2) the use of low-char binders when used; and 3) the use of proper atmospheres for the heating and sintering of the ZnS. In some embodiments, ZnS may be pressed and sintered without a polymeric binder present, thus eliminating the risk of C contamination. In some embodiments, a C-containing polymer may be added as a pressing aid, binder, or other function. Polymers with acceptable char levels may include any low-char binder for low-residual C pyrolysis in inert or reducing atmospheres such as: zinc stearate, stearic acid, polymerized alcohols such poly(vinyl alcohol), poly(methyl methacrylate), polyolefins (e.g. poly(propylene), poly(ethylene), lower molecular weight analogues such as paraffin and microcrystalline wax), and copolymers of the these materials. Additionally, or alternatively, inorganic binders may be used such as soluble silicates, soluble phosphates, or soluble aluminates. Silicates may degrade battery performance of iron negative electrodes, so it may be useful to use aluminates as inorganic binders. Additionally or alternatively, gaseous hydrogen may be included in the processing atmosphere to encourage the removal of residual C in the ZnS via the reaction Cs+2H_{2.g}→CH_{4.g} (or other, related reactions).

Various embodiments may include methods for making electrodes for batteries (e.g., iron negative electrode 14 of battery 10, negative electrode 102 of electrochemical cell 100, etc.) including forming a structure including an iron active material and a source of zinc and converting the source of zinc to zinc-sulfide on or in the structure through a sulfidation reaction. In various embodiments, the source of zinc may be in various forms, including as zinc oxide powder, a solution of zinc oxide, etc., and the zinc oxide may be in various forms, such as solid zinc oxide particles, agglomerated particles of zinc oxide, etc. In various embodiments the forming of structure and/or converting of the source zinc to zinc-sulfide on or in the structure may include one or more various operations including, but not limited to, exposure to one or more liquid and/or powder and/or gas solutions, drying, heating, cooling, pressing, sintering, etc.

In some embodiments, an electrode structure (for example, a structure used to form the iron negative electrode 14, the iron negative electrode 14 itself, etc.) may be placed on, dipped in, submerged in, or had poured onto it a gel, gel-like, or viscous mixture of ZnS, a gelling agent (e.g., agar, lignosulfonate, polyethylene glycol, etc.), and solvent (e.g., water, isopropyl alcohol, dichloromethane, dimethyl sulfoxide, dimethylformamide, toluene, etc.), where the minimum amount of solvent may be used to make the system flowable in the presence of the gelling agent (0.1-10 wt % gelling agent). In some mixtures, zinc sulfide may be the majority constituent. In others, the selected gelling agent may be the majority constituent. The infiltration of the electrode porosity by this mixture may be either allowed to progress naturally until sufficient mixture may be taken up into the electrode (an increase in mass equivalent to the desired ZnS wt % including the weight of solvent and organic) or accelerated by the use of vacuum until the same result is achieved. The mixture may then be dried at temperatures not exceeding 800 degrees Celsius. In some embodiments, the gelling agent is removed by washing with a compatible solvent in which the agent is sufficiently soluble (e.g., water, isopropyl alcohol, dichloromethane, dimethyl sulfoxide, dimethylformamide, toluene, etc.). In some embodiments, the gelling agent is removed by heating in a furnace until complete burnoff or evaporation as measured by change in mass. In some embodiments, the gelling agent may be partially removed until the desired mass remains in the electrode or until the formation of sufficient char.

In one embodiment, a sol gel mixture, consisting of a zinc oxide compound and a sulfide source (e.g., Na₂S, H₂S), may be used to introduce additives to an electrode structure (for example, a structure used to form the iron negative electrode 14, the iron negative electrode 14 itself, etc.). The electrode structure may be dipped fully or partially in the zinc oxide solution, which consists of a zinc oxide mixed with solvent (e.g., water, isopropyl alcohol, dichloromethane, dimethyl sulfoxide, dimethylformamide, toluene, etc.) and a gelling agent (e.g., agar, lignosulfonate, polyethylene glycol, etc.), before exposure to a solution of Na₂S or gaseous H₂S. The electrode structure may then be dried in air or in a furnace at temperatures not exceeding 800 degrees Celsius to form ZnS. Formation can be confirmed by XRD of representative samples from the electrode as well via ICP-OES with a mass ratio of approximately 1:1 Zn:S (theoretical acceptable range=0.5:1 to 2:1).

The low solubility of ZnS compared to soluble sources of sulfide (e.g., Na₂S, K₂S), allows for the preferential formation of ZnS in solution, where relative solubility is determined through comparison of the solubility products (Ksp) of the respective compound in water. This exchange reaction of ZnO with a soluble sulfide as facilitated by a solvent can be summarized as ZnO+Na₂S+H₂O→ZnS+2 NaOH or equivalently Zn(OH)₄²⁻ +Na₂S→ZnS+2 NaOH+2 OH—, where the solvent shown here is water over a range of pHs. This exchange with more soluble sulfides to form ZnS is known to happen readily in alkaline electrolytes. Similar substitution reactions are accessible using gaseous hydrogen sulfide (H₂S) or other sulfur-containing gases, e.g., ZnO+H₂S (g)→ZnS+H2 (g). As such, any embodiment that allows for the addition of ZnO as particles or agglomerates could then subsequently be exposed to a source of sulfur-containing ions (e.g. S²⁻, HS⁻, etc.) to form ZnS particles or agglomerates of a similar size to the initial agglomerates. The surface area and porosity of the particulate could be engineered to allow for conversion of ZnO to ZnS on the timescale of interest, where that timescale may be dependent on the conversion method selected (e.g. gaseous H₂S vs. Na₂S). In an illustrative embodiment, ZnO may be placed in a KOH-based solvent (6-8 M KOH) with an addition of dissolved sodium sulfide between 10 and 750 mM. The molar ratio of sodium sulfide to the ZnO may be between 1 and 2. In this illustrative embodiment, the ZnO may react to form ZnS within 1 week at room temperature as shown via XRD verification. This conversion process may usefully occur inside a battery cell if the KOH-based solvent is the electrolyte for the cell, thereby combining the ZnS synthesis step and the step of filling the cell with electrolyte. In another illustrative embodiment, ZnO may be converted to ZnS via exposure to H₂S gas at high temperatures. In some cases, the ZnO may be embedded in a matrix of iron-containing compounds such as metallic iron and iron oxides, hydroxides, and oxy-hydroxides. In some cases, the activity of the sulfur may be controlled such that the ZnO undergoes a sulfidation reaction, but other components of the blend (such as the iron) do not undergo sulfidation. The selective sulfidation of ZnO without sulfidation of Fe-containing species may be achieved by, e.g., controlling the ratio of the partial pressures of H₂S and H₂. Such a controlled sulfidation reaction may limit the total amount of sulfur added to the powder mix—this is advantageous for electrochemical performance and durability. Too high of starting sulfur concentrations can lead to sulfate accumulation in the electrolyte and therefore to sulfate precipitation. The reaction of ZnO with H₂S may occur at fairly low temperatures, including as low as 250° C., with conversion timescales on the order of several (4 to 9) hours. Faster kinetics may be obtained by increasing the temperature to increase the reaction kinetics to, e.g., 300 or 400° C. Complete sulfidation may be achieved between 400 and 600° C. in times between 10 and 60 minutes with H₂S concentrations in the inlet of the reactor between 0.25% and 1%. This high temperature sulfidation process may be performed during the cooling phase of a sintering or hot pressing operation, thereby taking advantage of heat already imparted to the electrode during the electrode formation process.

The sulfidation reactions discussed above could be applied to solid ZnO particles, or to agglomerates of ZnO particles (sometimes called ZnO granulate). The specific surface area of the ZnO particles may be tuned to permit sufficient sulfidation kinetics to achieve low processing costs and fast processing times.

In some embodiments, the sulfidation reaction of ZnO by H₂S may be combined with a high temperature processing step for the iron material. As an example, a sintered or hot pressed iron negative electrode (e.g., iron negative electrode 14, etc.) containing ZnO may be formed, and during the cooling process H₂S may be added to the cooling gas stream so that the ZnO converts into ZnS in-situ in the powder bed. Such an in-situ sulfidation step may usefully take advantage of the part already being hot, and may further usefully avoid the direct reduction of ZnS by metallic Fe. The direct reduction of ZnS by metallic Fe is undesirable as it leads to loss of ZnS and therefore increased cost of resulting Fe electrodes. The direct reduction of ZnS by Fe is only kinetically/thermodynamically facile above 800° ° C., whereas the sulfidation reaction of ZnO to ZnS may take place at much lower temperatures. There is therefore a significant, wide temperature window where in-situ sulfidation could usefully take place during thermal processing of iron negative electrodes.

One or more of the previous embodiments discussed above, including the use of binders or pore formers, may be combined with one or more of the methods discussed above for making electrodes for batteries (e.g., iron negative electrode 14 of battery 10, negative electrode 102 of electrochemical cell 100, etc.). For example, ZnO agglomerates as discussed herein may be formed using one or more binders in manners similar to the formation of ZnS agglomerates as discussed above. In another non-limiting example, a Na₂S pore former of an appropriate particle size, either as produced through chemical synthesis or through granulation, could be introduced to an iron powder mix for an electrode before pressing to enable formation of an electrode with sufficient porosity. After formation of the electrode, the Na2S could be dissolved on exposure to an appropriate solvent, which could then facilitate reaction of the sulfide with the ZnO to form ZnS in the electrode. In another embodiment, ZnO agglomerates could be introduced to the electrode prior to processing. After processing, the electrode could then be exposed to an electrolyte containing sulfide (e.g., dissolved Na2S, K2S, soluble sulfides, or mixes thereof). The sulfide ions are then known to exchange to form ZnS in place of the ZnO.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Further, any step of any embodiment described herein can be used in any other embodiment. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the following claims and the principles and novel features disclosed herein.

What is claimed is:

1. A method for making an electrode for a battery, comprising:
forming an electrode structure comprising an iron active material and a source of zinc; and
converting the source of zinc to zinc-sulfide on or in the electrode structure through a sulfidation reaction.

2. The method of claim 1, wherein the source of zinc comprises a zinc oxide powder.

3. A method of making an electrode for a battery, comprising:
contacting an electrode structure comprising an iron active material with a solution comprising dissolved zinc; and
exposing the solution contacted structure to a sulfide source to convert at least a portion of the dissolved zinc to zinc sulfide.

4. The method of claim 3, wherein the sulfide source is a solution comprising Na₂S.

5. The method of claim 3, wherein the sulfide source is a gas comprising H₂S.

6. The method of claim 3, wherein the solution comprising dissolved zinc comprises a solvent and a gelling agent.

7. The method of claim 3, further comprising drying the exposed solution contacted structure, wherein the drying occurs at one or more temperatures at or below 800 degrees Celsius.

8. The method of claim 7, wherein the drying occurs in a furnace.

9. A method of making an electrode for a battery, comprising:
forming a sulfidation solution comprised of a solvent and a sulfide source;
forming an electrode structure comprising an iron active material and a solid zinc source;
contacting the electrode structure with the sulfidation solution; and
maintaining the sulfidation solution in contact with the electrode structure for a period of time such that zinc sulfide is incorporated on or in the electrode structure.

10. The method of claim 9, wherein:
the sulfidation solution is a component of an electrolyte solution; and
contacting the electrode structure with the sulfidation solution comprises adding the sulfidation solution to a battery cell including the electrode structure such that the sulfidation solution contacts the electrode structure.

11. The method of claim 9, wherein the solvent comprises KOH and the sulfide source comprises Na₂S.

12. The method of claim 9, wherein the solid zinc source is formed from solid zinc oxide particles or agglomerated particles of zinc oxide.

13. The method of claim 12, wherein a molar ratio of Na₂S in the sulfidation solution to zinc oxide in the electrode structure is between 1 and 2.

14. The method of claim 13, wherein the period of time is less than 168 hours.

15. A method of making an electrode for a battery, comprising:
forming a structure comprising an iron active material and a solid source of zinc by one or more processes performed at or above a first processing temperature; and
exposing the formed structure to a sulfide source gas while maintaining a selected concentration of the sulfide source gas.

16. The method of claim 15, wherein the one or more processes performed at or above the first processing temperature comprise one or more of sintering and hot pressing.

17. The method of claim 15, wherein exposing the formed structure to the sulfide source gas while maintaining the selected concentration of the sulfide source gas comprises exposing the formed structure to the sulfide source gas while maintaining the selected concentration of the sulfide source gas and a second processing temperature that is below the first processing temperature such that a sulfidation reaction of the zinc oxide occurs to form zinc sulfide.

18. The method of claim 17, wherein the first processing temperature is at or above 800 degrees Celsius and the second processing temperature is at or below 600 degrees Celsius.

19. The method of claim 17, wherein the second processing temperature is at or below 400 degrees Celsius.

20. The method of claim 15, wherein the sulfide source gas is H₂S and the selected concentration of the sulfide source gas is between 0.25% and 1%.

21. The method of claim 15, wherein the exposing the formed structure to the sulfide source gas occurs as part of a cooling phase of a last of the one or more processes used to form the formed structure.

22. The method of claim 15, wherein the zinc oxide is formed from solid zinc oxide particles or agglomerated particles of zinc oxide.
